(19) United States
(12) Patent Application Publication
(10) Pub. No.: US 2021/0332951 A1
(43) Pub. Date: Oct. 28, 2021

(54) METHOD FOR RESTARTING FLOW IN WAXY CRUDE OIL TRANSPORTING PIPELINE

(71) Applicant: INDIAN INSTITUTE OF TECHNOLOGY BOMBAY, Mumbai (IN)

(72) Inventors: Lalit Kumar, Mumbai (IN); Lomesh Tikariha, Mumbai (IN)

(21) Appl. No.: 17/233,722

(22) Filed: Apr. 19, 2021

(30) Foreign Application Priority Data
Apr. 22, 2020 (IN) 202021017317

(51) Int. Cl. F17D 1/18; B08B 9/032

(52) U.S. Cl. CPC F17D 1/18; B08B 9/0328

(57) ABSTRACT

A method (400) for restarting flow in a waxy crude oil transporting pipeline (100), comprising: dividing (402) the gel plug into plurality of smaller gel segments (112, 114, 116) by removing a fraction of gel volume creating plurality of voids (132, 134), introducing (404) a compressible fluid into each of the voids; and applying (406) a pressure at first end (112A) of a first gel segment (112) contiguous to a pumping unit thereby creating a high pressure gradient between first end and second end (112B) of the first gel segment, causing the first gel segment to degrade and move towards a first void (132) thereby compressing the compressible fluid, the movement of the gel segment deforms and breaks the gel segment whereby the broken gel segment migrates towards a next gel segment (114) until all the gel segments are sequentially broken and flow of the waxy crude oil restarts.

### CROSS-REFERENCE TO RELATED PATENT APPLICATION

This application claims priority to and the benefit of Indian Patent Application No. 202021017317 Filed on 22 Apr. 2020, which is incorporated herein in its entirety by reference.

### FIELD OF THE INVENTION

The invention generally relates to a method of restarting flow in waxy crude oil transporting pipeline. More particularly, the invention relates to a method of restoring flow in pipelines where the flow of oil is being impeded by the formation of a gel plug composed of waxy oil.

### BACKGROUND OF THE INVENTION

Crude oil is often produced in remote locations away from where it will be consumed. Therefore, transportation networks have been built to transport crude oil to refineries where it is processed. A commonly known method of transporting oil over long distances is via pipelines. Pipelines require significantly less energy to operate and have a lower carbon footprint compared to other methods of transporting oil.

However, the pipeline transportation is affected by ambient weather conditions. This includes pipelines that are placed on the subsea or cold climate (where the ambient temperature is less than wax appearance temperature (WAT)) and are thus subjected to cold ambient temperatures of the surrounding. Waxy crude oil in the pipelines is a complex multi-component mixture of hydrocarbons, also contain high molecular weight asphaltenes and waxes. The heat loss to cold ambient during its transportation leads to the temperature of oil falling below its pour point. During this period the precipitated solids agglomerates and form a crystal network. A large increase in flow resistance of these hydrocarbons at relatively low ambient temperature increases the pumping losses on its transportation. Besides, the occasional maintenance and emergency shut down requirements further enhances the heat loss to cold ambient conditions. Thus, crude oil forms a strong gel-like network throughout the pipeline. Thus, the flow of the oil is impeded and production and transportation of heavy and extra-heavy crude oils in cold ambient conditions invites major flow assurance issues. To restart flow, pressure much higher than the pressure applied at normal operations needs to be applied at the inlet section of the choked pipeline. However, the requirement of a high-pressure gradient to degrade the gel structure and clear the pipeline is limited by the pump capacity and the pipeline design and material.

One solution to this problem is offered by Zagustin et al. (U.S. Pat. No. 4,745,937 A). Zagustin et al describe a process for restarting core flow with very viscous oils after a long standstill period. The procedure described by Zagustin et al includes injecting a less viscous immiscible fluid such as water into the flow of high resistive crude oil. During the standstill operation, the process of stratification between the phases develops a high resistive core plug surrounded by a low resistive annular layer of water. During the flow restart, low resistive fluid in between core and pipe wall ease the flow restart process. However, a continuous supply of water demands extra pumping facilities. Moreover, the formation of a uniform annular water layer surrounding the oil plug is not practical.

Further Dunlap et al. (U.S. Pat. No. 3,791,395 A) disclose a method for restarting the flow of gelled oil. Accordingly, Dunlap et al claim a method of reducing start-up pressure requirement by progressively degrading part of the gel plug. In this scheme, before application of restart pressure, a pressure pulse or cycle (higher than normal operating pressure) is applied to part of the gel plug. As pressure pulse travels through the gel plug, it degrades portion of the gel plug. Subsequent cycles further degrade a larger portion of the gel plug, as the pulse travels through the previously degraded gel segment. This process is continued until the yield pressure requirement is within the pressure limitations. However, in the case of a long pipeline, this slow gel degradation process delays the restoring time and creates other collateral problems. Furthermore, yielded gel can relax and the gel network can reform with time, resulting in a hindrance in degradation of the downstream gel.

Hence, there is a need in the art for a method which addresses at least the aforementioned problems.

### SUMMARY OF THE INVENTION

The present invention discloses a method for restarting flow in a waxy crude oil transporting pipeline, the flow of oil in the pipeline being impeded by formation of a gel plug composed of oil, the method comprising: dividing the gel plug into plurality of smaller gel segments by removing a fraction of gel volume from predetermined locations along the length of the gel plug thereby creating plurality of voids, each of the gel segments having a first end and a second end; introducing a compressible fluid into each of the voids; and applying a pressure at first end of one of a first gel segment contiguous to a pumping unit thereby creating a pressure gradient between the first end and the second end of the first gel segment, the high pressure gradient across the first gel segment causes the first gel segment to degrade and move towards a first void thereby compressing the compressible fluid, the movement of the gel segment deforms and breaks the gel segment whereby the broken gel segment migrates towards a next gel segment until all the gel segments are sequentially broken and flow of the waxy crude oil restarts.

According to an embodiment of the invention, the volume of compressible fluid introduced into the void is equal to the fraction of gel volume removed. In a further embodiment of the invention, the size of the void to be created in between the gel segments is determined in terms of fluid compressibility and yield strength of the gel segment.

According to an embodiment of the invention, the method comprises the step of applying a pressure at the first end of the first gel segment located contiguous to the inlet of the pipeline thereby creating a pressure gradient across the first get segment sufficient to degrade the first gel segment.

Further, according to an embodiment of the invention, the compressible gas in the void prevents the further propagation of pressure allowing a high pressure gradient to establish in the gel segments sequentially.

According to a further embodiment of the invention, the method comprises the step of determining a length of the pipeline blocked with the gel plug. In another embodiment of the invention, length of a gel segment is less than a threshold value ‘L’, the threshold value ‘L’ dependent on pressure to be applied on the gel segment, internal diameter of the pipeline, and yield strength of the gelled oil.

In an embodiment of the invention, the compressible fluid is an uncompressed gas. In another embodiment of the invention, the uncompressed gas is a combination of one or more compressible inert gases at normal pressure. In a further embodiment of the invention, the uncompressed gas is nitrogen at normal pressure.

In a further embodiment of the invention, the fraction of gel volume is removed and the compressible fluid is added to the pipeline by making incisions in the pipeline, and subsequently resealing the pipeline. In an embodiment of the invention the fraction of gel volume is removed by using spades; and in another embodiment of the invention the fraction of gel volume is removed by siphoning off the waxy crude oil after heating the fraction of gel volume.

### BRIEF DESCRIPTION OF THE INVENTION

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

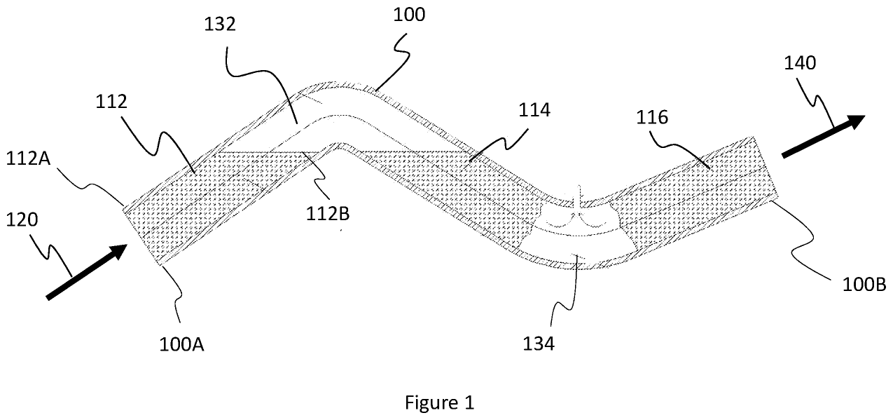

FIG. 1 is a schematic representation of a pipeline transporting waxy crude oil, with a gel plug impeding flow of oil.

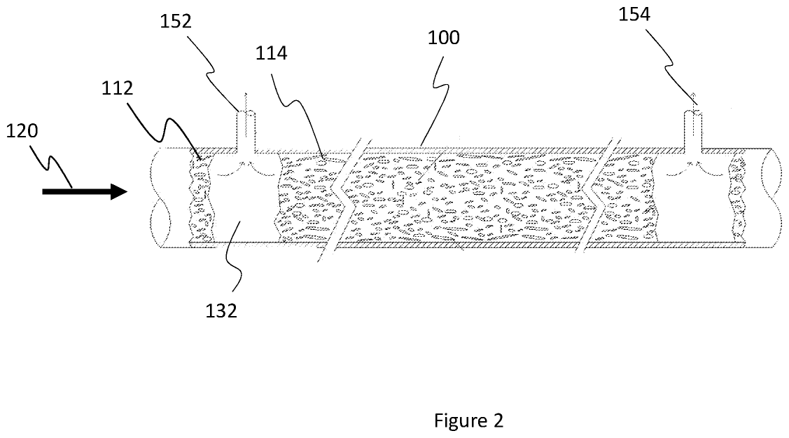

FIG. 2 is a schematic representation of a pipeline transporting waxy crude oil, with a gel plug impeding flow of oil.

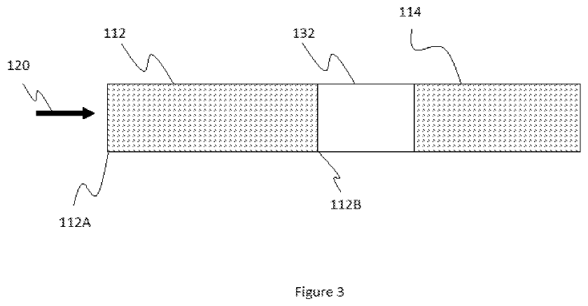

FIG. 3 is a schematic representation of an inlet of a pipeline transporting waxy crude oil, with a gel plug impeding flow of oil.

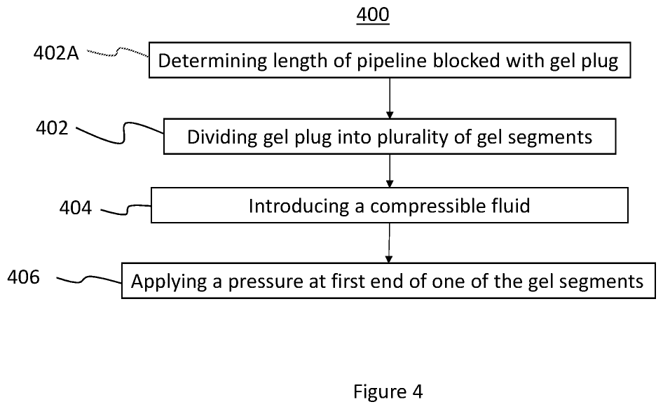

FIG. 4 is a flowchart illustrating a method for restarting flow in a waxy crude oil transporting pipeline.

### DETAILED DESCRIPTION OF THE INVENTION

The present invention is directed to a method for restarting flow in a waxy crude oil transporting pipeline.

As shown in FIGS. 1 and 2, waxy crude oil is transported in a pipeline 100 from an inlet 100A to an outlet 100B. The flow of oil in the pipeline 100 is impeded by the formation of a gel plug composed of oil. The (100) may also be blocked due to wax, asphaltene, resin, or any combinations thereof.

As shown in FIG. 4, the method comprises of step 402 in which the gel plug is divided into a plurality of smaller gel segments 112, 114, 116 by removing a fraction of gel volume from predetermined locations along the length of the gel plug. This creates a plurality of voids 132, 134. Each gel segment has a first end 112A and a second end 112B. The method 400 comprises a further step of introducing a compressible fluid in the voids 132, 134 to replace the fraction of gel volume removed. In an embodiment of the invention, the fraction of gel volume is removed and the compressible fluid is added to the pipeline 100 by making incisions 152, 154 in the pipeline 100. After the incisions 152, 154 have been used to successfully remove the fraction of gel volume and add the compressible fluid, the pipeline 100 is resealed. According to an embodiment of the invention, the volume of compressible fluid introduced in the void is equal to the fraction of the gel volume removed from the pipeline 100. According to a further embodiment of the invention, the fraction of gel volume is removed by using spades or by siphoning off the crude oil in gel form or in liquid form after heating the gel volume.

The method comprises a further step 406 of applying a pressure at the first end 112A of one of the gel segments 112, which is illustrated in FIG. 3. The pressure 120 applied creates a pressure gradient between the first end 112A and the second end 112B of the gel segment 112. According to an embodiment of the invention, the pressure 120 applied at the first end 112A of the gel segment 112 is contiguous with corresponds with inlet 100A of the pipeline 100. The presence of compressible fluid contiguous to a second end 112B of the gel segment 112 does not allow pressure to propagate downstream without movement of the gel segment 112. Thus, a high pressure gradient is established across the gel segment 112 sufficient to overcome the yield stress requirement of gel segment 112.

The high pressure gradient created by the pressure 120 applied causes the gel segment 112 to degrade to move towards the void 132. Thus, the compressible fluid in the void 132 is compressed. The movement of the gel segment 112 leads to the further degradation and breaking of the gel segment 112. Thus, the broken gel segment 112 offers a low flow resistance allowing the pressure to develop gradually across the next gel segment 114. A similar pressure gradient now acts on the next gel segment 114 and causes the degradation and breaking of the next gel segment 114. This process continues until all the gel segments are sequentially broken down and flow of the waxy crude oil restarts.

In an embodiment of the invention, the method 400 comprises a step 402A of determining a length of the pipeline (100) that is blocked with the gel plug. The pipeline 100 blocked with the gel plug is divided into gel segments having length less than a threshold value L. The threshold value L is dependent on the pressure 120 to be applied at the inlet section of the pipeline 100, internal diameter of the pipeline 100, and yield strength of the gelled oil. This is determined by the formula.

L<(D/4*P/τ_{y}) (1)

In Equation (1) herein above,

L=threshold length of the gel segment;

D=diameter of the pipeline;

P=Applied pressure;

τ_{y}=Yield stress of the gelled oil

According to an embodiment of the invention, the length of the pipeline 100 in which the compressible fluid is introduced is large enough to create sufficient deformation in the gel segments to cause the gel segments to break. For this, the length of the section of the pipeline from where gel needed to be removed given is by:

ΔL/R>>γₛ/(χ_{θ}ΔP) (2)

In an embodiment of the invention, equation (2) herein above is represented by:

ΔL/R≥3γₛ/(χ_{θ}ΔP) (3)

In equation (2) and (3) herein above,

ΔL=length of the pipeline in which compressible fluid is introduced;

R=radius of the pipeline;

γₛ=strain in the gel where stress becomes maximum;

χ_{θ}=isothermal compressibility of the gas; and

ΔP=change in pressure in the gas phase after compression.

In an embodiment of the invention, the compressible fluid used in the method 400 described herein above comprises an uncompressed gas. In a further embodiment, the uncompressed gas is a combination of one or more compressible inert gases at normal pressure. In another embodiment of the invention, the uncompressed gas is nitrogen at normal pressure.

Advantageously, the sequential breaking of gel segments is achieved by a lower applied pressure. Thus, this invention offers an energy efficient method for restarting flow in a waxy crude oil transporting pipeline.

While the present invention has been described with respect to certain embodiments, it will be apparent to those skilled in the art that various changes and modifications may be made without departing from the scope of the invention as defined in the following claims.

We claim:

1. A method (400) for restarting flow in a waxy crude oil transporting pipeline (100), the flow of oil in the pipeline (100) being impeded by formation of a gel plug composed of oil, the method (400) comprising:
dividing (402) the gel plug into a plurality of smaller gel segments (112, 114, 116) by removing a fraction of gel volume from predetermined locations along the length of the gel plug thereby creating a plurality of voids (132, 134), each of the gel segments (112, 114, 116) having a first end (112A) and a second end (112B);
introducing (404) a compressible fluid into each of the voids (132, 134); and
applying (406) a pressure (120) at the first end (112A) of a first gel segment (112) contiguous to a pumping unit thereby creating a high pressure gradient between the first end (112A) and the second end (112B) of the first gel segment (112), the high pressure gradient across the first gel segment (112) causes the first gel segment (112) to degrade and move towards a first void (132) thereby compressing the compressible fluid, the movement of the gel segment (112) deforms and breaks the gel segment (112) whereby the broken gel segment (112) migrates towards a next gel segment (114) until all the gel segments are sequentially broken and flow of the waxy crude oil restarts.

2. The method (400) as claimed in claim 1, comprising the step of applying a pressure (120) at the first end (112A) of the first gel segment (112) located contiguous to the inlet (100A) of the pipeline (100) thereby creating a high pressure gradient across the first gel segment (112) sufficient to degrade the first gel segment (112).

3. The method (400) as claimed in claim 1, wherein the compressible gas in the void (132, 134) prevents the further propagation of pressure, allowing a high pressure gradient to establish in the gel segments (112, 114, 116) sequentially.

4. The method (400) as claimed in claim 1, wherein the volume of compressible fluid introduced into the void (132, 134) is equal to the fraction of gel volume removed.

5. The method (400) as claimed in claim 1, wherein the size of the void (132, 134) to be created in between the gel segments (112, 114, 116) is determined in terms of fluid compressibility and yield strength of the gel segment (112, 114, 116).

6. The method (400) as claimed in claim 1, comprising the step of determining (402A) a length of the pipeline (100) blocked with the gel plug.

7. The method (400) as claimed in claim 1, wherein length of a gel segment is less than a threshold value the threshold value dependent on pressure to be applied on the gel segment, internal diameter of the pipeline, and yield strength of the gelled oil.

8. The method (400) as claimed in claim 1, wherein the compressible fluid comprises an uncompressed gas.

9. The method (400) as claimed in claim 8, wherein the uncompressed gas is a combination of one or more compressible inert gases at normal pressure.

10. The method (400) as claimed in claim 8, wherein the uncompressed gas is nitrogen at normal pressure.

11. The method (400) as claimed in claim 1, wherein the fraction of gel volume is removed and the compressible fluid is added to the pipeline (100) by making incisions (152, 154) in the pipeline (100), and subsequently resealing the pipeline (100.

12. The method (400) as claimed in claim 11, wherein the fraction of gel volume is removed by using spades.

13. The method (400) as claimed in claim 11, wherein the fraction of gel volume is removed by siphoning off the waxy crude oil after heating the fraction of gel volume.
